(19) United States
(12) Patent Application Publication
(10) Pub. No.: US 2013/0298007 A1
(43) Pub. Date: Nov. 7, 2013

(54) DETERMINING PAGE LOADING OF USER INTERFACES OF WEB APPLICATIONS

(71) Applicant: INTERNATIONAL BUSINESS MACHINES CORPORATION, Armonk, NY (US)

(72) Inventors: Peter J. Cullen, Hursley (GB); John W. Duffell, Hursley (GB); Sam Marland, Bangor (GB); Alisdair W. Owens, Hursley (GB)

(73) Assignee: International Business Machines Corporation, Armonk, NY (US)

(21) Appl. No.: 13/862,080

(22) Filed: Apr. 12, 2013

(30) Foreign Application Priority Data
Apr. 18, 2012 (GB) GB1206788.0

(51) Int. Cl. G06F 3/0481

(52) U.S. Cl. CPC G06F 3/0481
USPC 715/234

(57) ABSTRACT

Embodiments relate to determining page loading of user interfaces of web applications. An aspect includes loading a web page at a browser of a client, the web page comprising a plurality of scripting codes. Another aspect includes providing a wrapper function for an existing function in the browser. Another aspect includes determining one or more scripting codes that waiting to run in the web page, and incrementing a counter value for each of the one or more scripting codes that waiting to run in the web page. Another aspect includes determining one or more scripting codes that have that have started execution or completed execution, and decrementing the counter value for each of the one or more scripting codes that complete execution or started execution. Another aspect includes based on determining that the counter value returns to a zero count, determining that the web page is loaded in the browser.

### CROSS-REFERENCE TO RELATED APPLICATION

The present application claims priority to United Kingdom Patent Application No. 1206788.0, filed on Apr. 18, 2012, and all the benefits accruing therefrom under 35 U.S.C. §119, the contents of which in its entirety are herein incorporated by reference.

### BACKGROUND

The present disclosure relates generally to web applications, and more specifically, to determining page loading of user interface of web applications.

Manually testing web user interfaces is an extremely time consuming and error prone activity which is why automated user interface testing is so important for organizations who develop web applications. For each new version, the same set of tasks needs to be carried out. If the development cycles are short then this can mean a large amount of time is spent manually testing web UIs.

Scripting languages are widely used for client-side scripting on the web. ECMAScript™ is the scripting language standardized by Ecma International in the ECMA-262 specification and ISO/IEC 16262. The ECMAScript standard is used in the form of several well-known dialects such as JavaScript™, Microsoft™ JScript™, and ActionScript™. The following description often refers to JavaScript but may apply to any scripting which can manipulate the DOM (Document Object Model) tree of the document.

It is difficult, if not impossible, to know when a page has fully loaded if it uses any JavaScript to update the page. This is a problem because many large web applications use JavaScript to improve their UI's, for example, Google™, W3C™ (World Wide Web Consortium) intranet site, International Business Machines Corporation™ (IBM) BusinessSpace™, and Facebook™.

Current technologies include waiting for certain elements to appear on the page, but this is an unreliable method because when an element appears there may still be JavaScript running on the page especially if several processes are happening in parallel. Also a user has to know exactly what elements they expect to appear after each interaction the code makes with the page. This is simply not possible if a user is checking for the existence of an element or counting the number of elements.

### BRIEF SUMMARY

Embodiments include a method, system, and computer program product for determining page loading of user interfaces of web applications. An aspect includes loading a web page at a browser of a client, the web page comprising a plurality of scripting codes. Another aspect includes providing a wrapper function for an existing function in the browser. Another aspect includes providing a counter, the counter having a counter value. Another aspect includes determining one or more scripting codes that waiting to run in the web page, and incrementing the counter value for each of the one or more scripting codes that waiting to run in the web page. Another aspect includes determining one or more scripting codes that have that have started execution or completed execution, and decrementing the counter value for each of the one or more scripting codes that complete execution or started execution. Another aspect includes based on determining that the counter value returns to a zero count, determining that the web page is loaded in the browser.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

FIG. 1 is block diagram of a system for determining page loading of user interface of web applications in accordance with the an embodiment;

FIG. 2 is a block diagram of a computer system for determining page loading of user interface of web applications in accordance with an embodiment;

FIG. 3 is a flow diagram of a method of determining page loading of user interface of web applications in accordance with an embodiment; and

FIG. 4 is a schematic diagram of an example of a method for determining page loading of user interface of web applications in accordance an embodiment.

### DETAILED DESCRIPTION

Embodiments described herein are directed to determining page loading of user interface of web applications. Methods and systems are described for determining when a page has fully loaded of a user interface of a web application. A browser plugin may be provided which wraps around an existing function for calling scripting code whilst allowing other code to run. For example, existing functions include: JavaScript's setTimeout function or setInterval function, or XMLHttpRequest function. The described plugin code may be wrapped around the existing function whilst still calling their original function. JavaScript's setTimeout function or setInterval functions allow a piece of code to schedule a piece of code to execute after a certain delay or at set time intervals. XMLHttpRequest (XHR) is an API available in web browser scripting languages such as JavaScript. It is used to send hypertext transfer protocol (HTTP) or hypertext transfer protocol secure (HTTPS) requests directly to a web server and load the server response data directly back into the script. Data from the response can be used directly to alter the DOM of the currently active document in the browser window. The response data can also be evaluated by client-side scripting.

The described code may provide a counter which may be incremented and then decremented for calls to the function at all times. As a page loads, all the methods allowing scripting languages to be scheduled to run on a callback go through the method incrementing the counter. Once control is passed by the browser to the scheduled code, the method will decrement the counter. When the counter reaches 0 again the page is safe to interact with, for example, to execute tests upon. A test code may monitor the counters value at all times and may wait for the counter to be equal to 0 before executing any test code. The page can be guaranteed to have finished loading at this point.

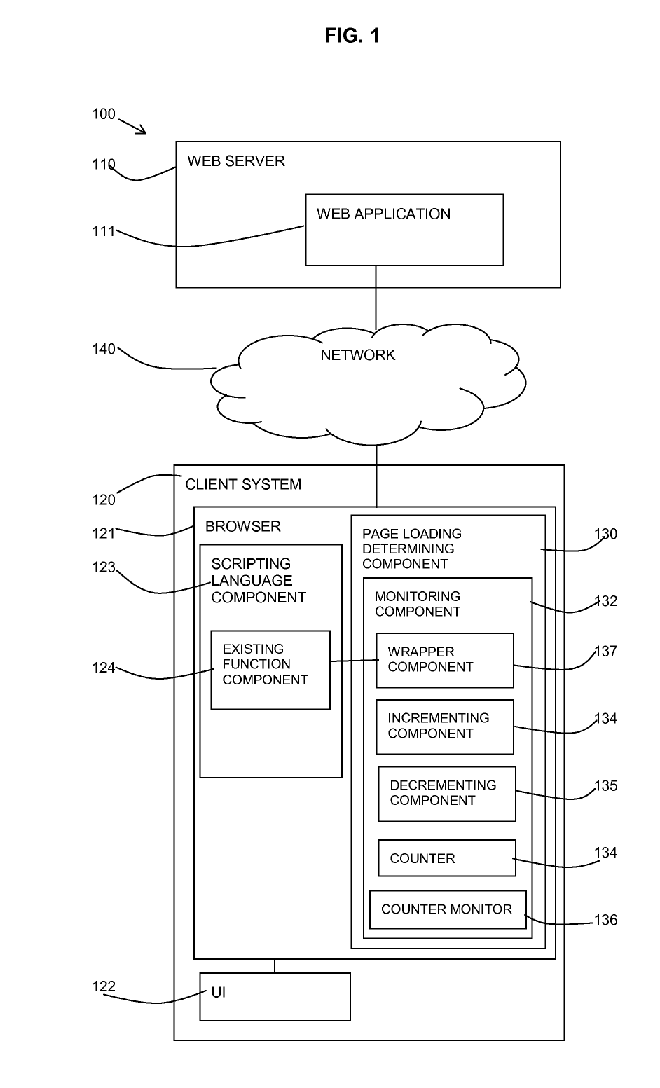

Referring to FIG. 1, a block diagram shows an example embodiment of a system 100 for determining page loading of user interface of web applications. A web application 111 may be provided on a web server 110 accessed by a client system 120 over a network 140 such as the Internet. A browser 121 at the client system 120 may access the web application 111 via the network 140 and download the content to the client system 120 for viewing and interacting with on a user interface (UI) 122. A browser 121 may include a scripting language component 123 for loading elements into the UI 122.

A page loading determining component 130 may be provided as a plug-in to the browser 121 in order to determine when a web page of a web application 111 has fully loaded at the client system 120. Page loading information is useful in many contexts in the field of programmatically driving user interfaces of web applications. An example use is in testing user interfaces of web applications. The page loading determining component 130 may include a monitoring component 132 for monitoring an existing function component 124 of the scripting language component 123 by providing a wrapper component 137 for the existing function component 124.

The monitoring component 132 may include an incrementing component 133 for incrementing a counter 134 when a piece of scripting code is monitored as waiting to be run. The monitoring component 132 may also include a decrementing component 135 for decrementing the counter 134 when the piece of scripting code is monitored as having executed or having started to execute. A counter monitor 136 may be provided to alert the user when the counter 134 returns to a zero count indicating that all scripting code has been loaded.

In one embodiment, a testing component may be provided at the client system or remote to the client system via a network for testing a UI of a web application. The testing component may include or operate with the described page loading determining component 130.

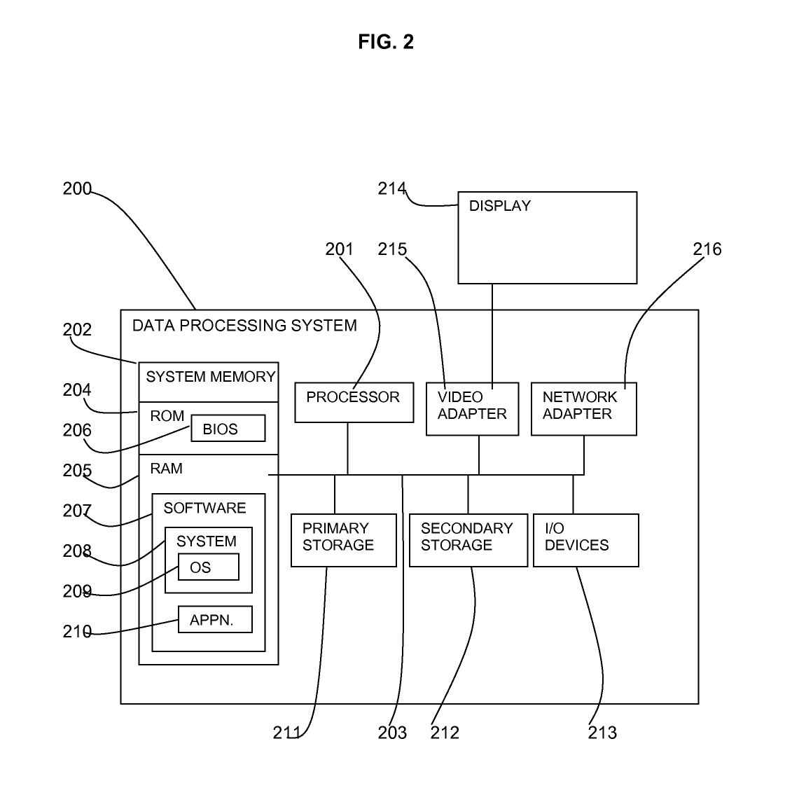

Referring to FIG. 2, an embodiment of a system for determining page loading of user interface of web applications includes a computing system 200 suitable for storing and/or executing program code including at least one processor 201 coupled directly or indirectly to memory elements through a system bus 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

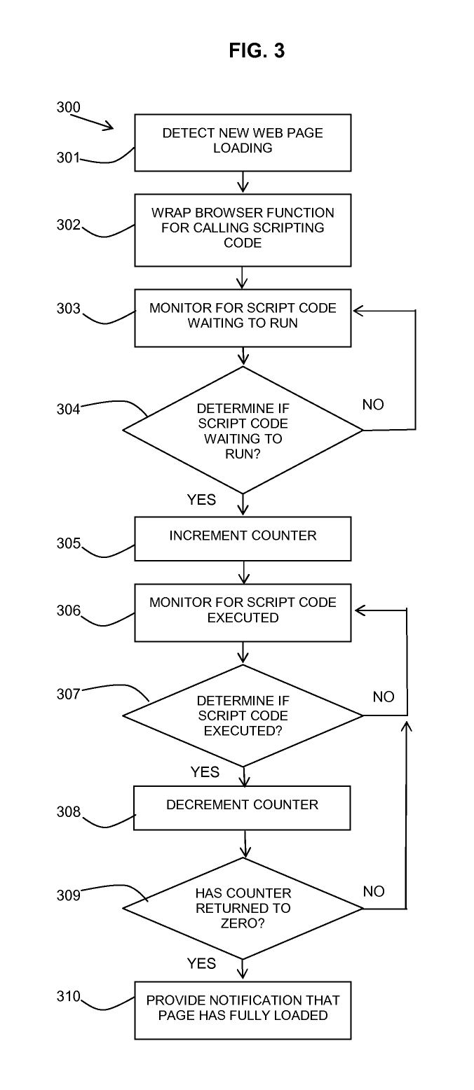

Referring to FIG. 3, a flow diagram 300 shows an example embodiment of the described method. It may be detected in block 301 that a new web page is loading at a client. An existing browser function for calling scripting code may be wrapped in block 302 by a monitoring function. The method may monitor in block 303 for scripting code waiting to run. This may be done by monitoring the calling of the wrapped function from a script. It may be determined in block 304 if a scripting code is monitored as waiting to run, if not, the method may continue to monitor. If it is detected, a counter may be incremented in block 305. The monitoring of scripting code waiting to run may still occur at all times, so there would typically be several pieces of scripting code waiting to run at the same time.

The method may also monitor in block 306 scripting code which has executed or started to execute. This may be done by monitoring the wrapped function callback. It may be determined in block 307 if the scripting code has executed or has started to execute, if not, the method may continue to monitor. If it has executed or started to execute, then the counter may be decremented in block 308.

It may be determined in block 309 when the counter returns to a zero count. If this is detected, a notification may be provided in block 310 that the page has fully loaded. If this is not yet detected, the monitoring on blocks 303, 306 may continue.

In one embodiment, rather than monitoring the completion of the scripting code, the start may be monitored. The flexibility is afforded because the scripting component is single threaded. This means that while the code is executing no other code could monitor the counter. In one embodiment, the counter may be monitored by a separate component which is not directly driven by the decrementing component. The process may continue once the page has fully loaded, as further interactions with the browser could cause scripting code to run (without a new web page loading) and it is beneficial to be able to determine when these in turn are completed.

A specific example embodiment is now described in which the scripting language is JavaScript and the existing function which is wrapped is a setTimeout function. The setTimeout function allows a piece of code to schedule a piece of code to execute after a certain delay. Importantly, while the delay is happening, other code can run. To wrap the setTimeout function, a handle is got to the window object of the browser, a reference to the original timeout function is stored, and the window.setTimeout is overwritten with a new function. The new function would increment a timeoutCounter variable, store the identifier (ID) in a list of valid timeout IDs, and then add a wrapper function to be called after the required delay. The wrapper function would decrement the timeoutCounter, delete the ID from the valid timeout IDs and then call the code that the original caller required. The browser also provides a clearTimeout function which would remove a pending timeout. This is overridden to check the timeout ID is valid, decrement the counter, and then call the browser function to clear the timeout itself. Similar methods may apply to the setInterval and XmlHttpRequest functionality.

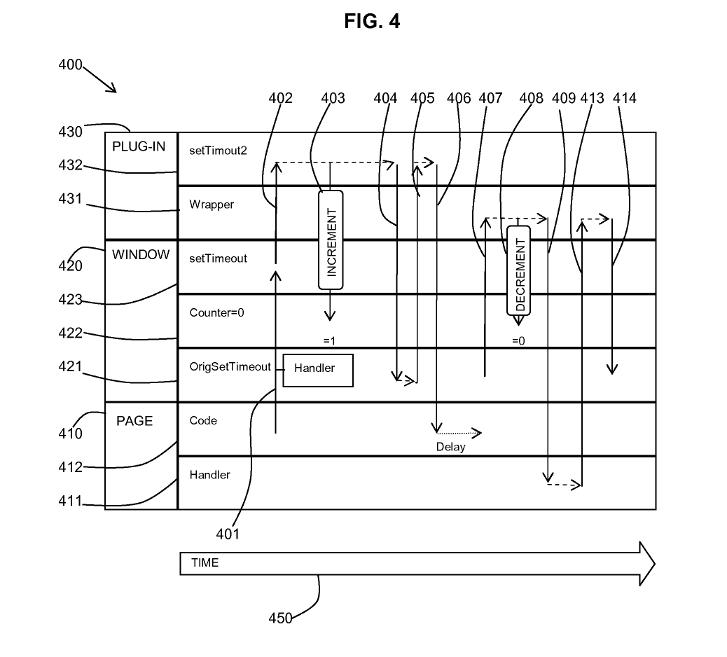

Referring to FIG. 4, a schematic diagram 400 illustrates a specific example embodiment of the described method of FIG. 3 in the form of calls made between components with time 450 shown from left to right of the figure. In this embodiment, a page 410 of a web application has code 412 and a handler 411. A window 420 has a reference OrigSetTimeout to a function 421, a Counter function 422 (starting at 0), and a setTimeout function reference 423. A plug-in 430 has a wrapper 431 and a setTimeout2 function 432. The original setTimeout function referenced by OrigSetTimeout is provided by the browser. The setTimeout2 function calls the original setTimeout function via OrigSetTimeout. The setTimeout2 function supplies a wrapper function 431 in the plug-in 430 as the function to call. Web application code 412 in the page 410 calls 401 a setTimeout to schedule code (labelled Handler in the diagram which is a reference to 411) to run after a delay. This redirects 402 to the overriding method (described as setTimeout2 432) which will increment 403 the counter 422 and call 404 the original setTimeout function 421. Call 404 supplies a reference to the wrapper function 431 around the code labelled Handler in the diagram. The method then returns 405 to the page as normal.

After a delay 406 in which the browser could schedule other code or perform user interaction, the browser will call back 407 to the wrapper function 431 that was provided to the browser's setTimeout method. This wrapper function 431 will decrement 408 the counter 422 and then pass control 409 to the code 412 that the page originally passed into the setTimeout call. The handler 411 then returns control 413 as normal to the wrapper 431 that called it, which then in turn returns control 414 back to the browser code that called it thus allowing the browser to continue as normal.

In various embodiments, all scripting language code on a page are determined to have finished running before any interaction is carried out with the page, for example, executing a test. A page loading determining system may be provided as a service to a customer over a network.

Embodiments may take the form of an entirely hardware embodiment, an entirely software embodiment or an embodiment containing both hardware and software elements. Some embodiments are implemented in software, which includes but is not limited to firmware, resident software, microcode, etc.

Embodiments may take the form of a computer program product accessible from a computer-usable or computer-readable medium providing program code for use by or in connection with a computer or any instruction execution system. For the purposes of this description, a computer usable or computer readable medium can be any apparatus that can contain or store the program for use by or in connection with the instruction execution system, apparatus or device.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

As will be appreciated by one skilled in the art, aspects of the present invention may be embodied as a system, method, computer program product or computer program. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Java and all Java-based trademarks and logos are trademarks or registered trademarks of Oracle and/or its affiliates.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For the avoidance of doubt, the term “comprising”, as used herein throughout the description and claims is not to be construed as meaning “consisting only of”. It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features. In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method for determining page loading of user interfaces of web applications, comprising:
loading a web page at a browser of a client, the web page comprising a plurality of scripting codes;
providing a wrapper function for an existing function in the browser, the wrapper function configured to perform a method comprising:
providing a counter, the counter having a counter value;
determining one or more scripting codes that waiting to run in the web page, and incrementing the counter value for each of the one or more scripting codes that waiting to run in the web page;
determining one or more scripting codes that have that have started execution or completed execution, and decrementing the counter value for each of the one or more scripting codes that complete execution or started execution; and
based on determining that the counter value returns to a zero count, determining that the web page is loaded in the browser.

2. The method of claim 1, further comprising monitoring the plurality of scripting codes for execution by the wrapper function.

3. The method of claim 1, wherein determining the one or more scripting codes that waiting to run in the web page comprises determining a number of scripting codes that are scheduled to run on a callback.

4. The method of claim 1, wherein determining the one or more scripting codes that have that have started execution or completed execution comprises determining that control is passed by the browser to scheduled code for the one or more scripting codes.

5. The method of claim 1, wherein the existing function comprises one of: a JavaScript's setTimeout function or setInterval function and a XMLHttpRequest (XHR) function.

6. The method of claim 1, comprising:
monitoring the counter value; and
interacting with the web page based on determining that the counter value is equal to zero.

7. The method of claim 1, wherein providing the wrapper function comprises providing a browser plugin which overrides a browser function while calling the existing function.

8. The method of claim 1, further comprising, after determining that the counter value has returned to the zero count, continuing to monitor the browser once the web page has fully loaded for additional scripting codes that are waiting to run in the web browser, and determining the additional scripting codes are completed.

9. A system for determining page loading of user interfaces of web applications, comprising:
a processor;
a client system for loading a web page at web browser of a client, the web page comprising a plurality of scripting codes;
a browser with a page loading determining component including a wrapper function for an existing function in the browser, the page loading determining component is configured to perform a method comprising:
providing a counter, the counter having a counter value;
determining one or more scripting codes that waiting to run in the web page, and incrementing the counter value for each of the one or more scripting codes that waiting to run in the web page;
determining one or more scripting codes that have that have started execution or completed execution, and decrementing the counter value for each of the one or more scripting codes that complete execution or started execution; and
based on determining that the counter value returns to a zero count, determining that the web page is loaded in the browser.

10. The system of claim 9, further comprising monitoring the plurality of scripting codes for execution by the wrapper function.

11. The system of claim 9, wherein determining the one or more scripting codes that waiting to run in the web page comprises determining a number of scripting codes that are scheduled to run on a callback.

12. The system of claim 9, wherein determining the one or more scripting codes that have that have started execution or completed execution comprises determining that control is passed by the browser to scheduled code for the one or more scripting codes.

13. The system of claim 9, wherein the existing function comprises one of: a JavaScript's setTimeout function or setInterval function and a XMLHttpRequest (XHR) function.

14. The system of claim 9, comprising:
monitoring the counter value; and
interacting with the web page based on determining that the counter value is equal to zero.

15. The system of claim 9, the wrapper function comprises browser plugin which overrides a browser function while calling the existing function.

16. The system of claim 9, further comprising, after determining that the counter value has returned to the zero count, continuing to monitor the browser once the web page has fully loaded for additional scripting codes that are waiting to run in the web browser, and determining the additional scripting codes are completed.

17. A computer program product for determining page loading of user interfaces of web applications, comprising:
a computer readable storage medium having computer readable program code embodied therewith, the computer readable program code configured to:
loading a web page at a browser of a client, the web page comprising a plurality of scripting codes;
providing a wrapper function for an existing function in the browser, the wrapper function configured to perform a method comprising:
providing a counter, the counter having a counter value;
determining one or more scripting codes that waiting to run in the web page, and incrementing the counter value for each of the one or more scripting codes that waiting to run in the web page;
determining one or more scripting codes that have that have started execution or completed execution, and decrementing the counter value for each of the one or more scripting codes that complete execution or started execution; and
based on determining that the counter value returns to a zero count, determining that the web page is loaded in the browser.

18. The computer program product of claim 17, further comprising monitoring the plurality of scripting codes for execution by the wrapper function.

19. The computer program product of claim 17, wherein determining the one or more scripting codes that waiting to run in the web page comprises determining a number of scripting codes that are scheduled to run on a callback.

20. The computer program product of claim 17, wherein determining the one or more scripting codes that have that have started execution or completed execution comprises determining that control is passed by the browser to scheduled code for the one or more scripting codes.
